(19) United States
(12) Patent Application Publication
(10) Pub. No.: US 2005/0058060 A1
(43) Pub. Date: Mar. 17, 2005

(54) K-byte extension and tunnel identifying scheme for tunnel-based shared mesh protection

(75) Inventors: Brett Caldwell, Nepean (CA); Peter Phelps, Nepean (CA); Evert E. DeBoer, Nepean (CA)

Correspondence Address: OGILVY RENAULT, 1981 MCGILL COLLEGE AVENUE, SUITE 1600, MONTREAL, QC, H3A2Y3, CA

(73) Assignee: NORTEL NETWORKS LIMITED, St. Laurent (CA)

(21) Appl. No.: 10/662,314

(22) Filed: Sep. 16, 2003

(51) Int. Cl. H04L 12/26

(52) U.S. Cl. 370/216

(57) ABSTRACT

A method for permitting a network element to transmit to a second network element a message over a link, that identifies a tunnel segment occupying predefined proportion of the data transport on the link, and a status of the tunnel, so that each tunnel may be provided with independent protection switching messaging involves providing an identifying scheme for locally identifying the tunnels passing through the tunnel segment. In order to permit this information to be sent over existing (narrow) automatic protection switching (APS) channels, the identifying scheme only provides a local identifier of the tunnel. To permit extended messaging to include messages that do not fit in a single K-byte overhead, extension bits are used to identify continuation of a message across multiple frames.

### CROSS-REFERENCE TO RELATED APPLICATIONS

This is the first application filed for the present invention.

### MICROFICHE APPENDIX

Not Applicable.

### TECHNICAL FIELD

The invention relates generally to protection provisioning in optical networks, and in particular to a method and apparatus for enabling tunnel-based protection messaging and control in a shared mesh network.

### BACKGROUND OF THE INVENTION

Synchronous optical networks (SONET) and synchronous digital hierarchy (SDH) networks are well known to provide reliable data transmission, in part because of their protection switching capabilities. More specifically, SONET, SDH, and a converged SONET-SDH standards have been developed to permit the conveyance of frame-based traffic, while providing numerous network reliability mechanisms. These networks have been deployed in linear (point-to-point), ring, and mesh configurations. Ring and linear configurations do not permit the arbitrary connection of individual nodes to existing network elements (NEs). Rather, within a ring configuration each NE is only connected to two adjacent NEs. Linear-configuration SONET/SDH networks are also constrained, in that the network is defined as a two NEs. Mesh-configured optical networks, on the other hand, can be configured in an unconstrained topology that is now in demand. It should be noted that ‘mesh’ in some areas of technology suggests a complete interconnection of nodes, or at least a network configuration where any two nodes are at most a few hops away, but no such limitation is intended by the term as used in the document.

The constraints of the linear and ring configurations facilitate NE identification, the interconnection of NEs, etc. and so installing the NEs, configuring and provisioning the NEs, and providing protection switching on networks of these configurations is considerably easier than on mesh-configured SONET/SDH networks. The problem of providing protection switching on mesh-configured networks is further exacerbated by response time requirements of protection switching, and because of the limited data transport available for exchanging data between the NEs for protection switching purposes.

The ability to provision tunnels through a network is another desirable capability. The term ‘tunnel’ as used in this document means an end-to-end traffic route of a predefined bandwidth that can traverse intermediate NEs. Tunnels permit the division of data transport capacity of specific links between NEs into respective proportions (tunnel segments), and to switch-connect these tunnel segments independently at the NEs, to form end-to-end tunnels between end points that are selected on demand. Further it is desirable to permit a working tunnel to “share” its protection tunnel with N other working tunnels. Such protection schemes are known in the art as 1:N, or shared, protection schemes. A protection tunnel is therefore required to provide transport for protection switching information to each of the N working tunnels. This would appear to require a significant number of identifying bits.

The data transmission units of the SONET and SDH standards, called frames, provide two bytes (known as the K1 and K2 bytes) for automatic protection switching (APS) data. As 8,000 frames are sent per second in all SONET/SDH implementations, the successive K1, K2 bytes provide an APS communications channel of up to 128K bits/s. In accordance with the prior art, the APS channel is designed to provide protection switching information for only one connection, and therefore is not adapted to support signaling for of each of the tunnels, and the respective sharing working tunnels.

While signaling can be provided between the NEs using a data communications channel (DCC) provided in the frame, in a manner known in the art, and software can be provided at a higher layer of functionality to provide tunnel-based protection switching information, there are problems with doing so. Principally, the signal latency within the DCC becomes unacceptably high when the DCC is being used for other traffic. Because the DCC is used by numerous applications, and because the DCC does not provide a mechanism for interrupting transmissions to transmit a more urgent item, and further because readily available standard-compliant hardware may not provide adequate interrupt-based handling of the DCC, the DCC may not consistently provide acceptable switching rates. In contrast, the K-bytes are generally handled with the interrupt-based high priority processing.

Another alternative is to use payload or unused overhead bytes of the frame that are not inspected according to the converged standard, to convey the protection switching information. Unfortunately hardware that inspects the payload or other uninspected bytes, at a required rate to make the system responsive, is very expensive.

Accordingly the prior art does not provide a cost-effective method for communicating protection switching information on a per tunnel basis, using a communications channel that is reliable and fast enough to provide acceptable protection switching.

Therefore there remains a need for a method for transmitting protection switching information between NEs of an optical network to permit tunnel-based protection switching.

### SUMMARY OF THE INVENTION

It is therefore an object of the invention to provide a method for transmitting protection switching information between NEs of an optical network, to permit tunnel-based protection switching.

It is also an object of the invention to provide a method for transmitting a protection switching message between NEs of a shared mesh network.

It is further an object of the invention to provide a method for transmitting a protection switching message between NEs of an optical network, when the protection switching message does not fit within a K-byte overhead of a single frame.

In accordance with one aspect of the invention, a method is provided for transmitting an automatic protection switching (APS) message from a first network element (NE) to a second NE of a frame-based optical network. The method involves inserting information into a K-byte overhead of a frame sent over a link from the first NE to the second NE. The information is used to identify a tunnel segment that occupies a predefined proportion of the link's capacity; a status of the tunnel segment; and a tunnel member associated with the proportion of the link's capacity. The method may involve inserting a tunnel entity identifier (ID) that identifies both the tunnel segment, and a tunnel member, if the tunnel segment is a part of a protection tunnel, and the working designation, if the tunnel segment is a part of a working tunnel. The tunnel entity ID may be an index of a packed lookup table

The method may further involve examining information to be sent in the APS message, and using a continuity of message indicator in an overhead of the frame to indicate that a balance of the APS message is being sent in a K-byte overhead of at least one subsequent frame.

Inserting the status of the tunnel segment may involve inserting a preemption priority value that identifies a reason for a protection switch request, the preemption priority value being associated with a hierarchy of the reasons for the protection switch requests. The preemption priority value may be associated with both a condition of, and a grade of service of, a tunnel associated with the tunnel member. Inserting the status of the tunnel segment may further include inserting an indication of the following: a state of occupancy of the tunnel segment by the working tunnel associated with the tunnel member, if the tunnel segment is a protection tunnel segment; whether the tunnel segment is selected, and is therefore transporting live traffic of the working tunnel associated with the tunnel member or the working tunnel passing through the tunnel segment; and a signal failure or a signal degrade condition of the tunnel occupying the tunnel segment.

In accordance with a second aspect of the invention, a method for transmitting a message on an automatic protection switch channel between a first network element (NE) and a second NE of an optical network, is provided. The method involves sending a first K-byte overhead followed by one or more follow-on K-byte overheads in respective sequentially validated frames over a link between the first and second NE, and using at least a continuity of message indicator of the first and follow-on K-byte overheads to indicate a beginning, and an end of the message. The continuity of message indicator may be set in the first K-byte overhead to indicate that it is a first of an extended message, and if the message requires more than one follow-on K-byte overhead, a first follow-on K-byte overhead is transmitted in a corresponding frame. The first follow-on K-byte overhead may have a length field that indicates a number of K-byte overheads in the message. Preferably the continuity of message indicator is set to a second value associated with the follow-on K-byte overheads so that each K-byte overhead that is part of the extended message is identifiable as such.

The method preferably further comprises inserting into the first K-byte overhead an identifier of a tunnel segment that occupies a predefined proportion of the link's capacity; a status of the tunnel segment; and a tunnel member that locally identifies a tunnel passing through the tunnel segment.

The method preferably further involves determining if the message is for adjacent NE signaling, and if it is not, sending the message as above. If the message is for adjacent NE signaling, a local message identifier is inserted in a K-byte overhead. The local message identifier is preferably a bit pattern that is not generally expected in K-bytes of other standard frame-based optical networks, to assist in troubleshooting network equipment connections.

Each follow-on K-byte overhead preferably includes a command code that identifies how a content field of the K-byte overhead is to be interpreted. The method therefore involves inserting the content into the content field, in accordance with the command code. The content field may be used for controlling transmission of K-byte messages, or for managing tunnels provisioned across the link.

In accordance with another aspect of the invention, an automatic protection switch (APS) signal processor of a network element (NE) of a mesh-connected, frame-based optical network, is provided. The APS signal processor comprises at least a receiver for receiving APS messages in a K-byte overhead of frames transported over a bidirectional link from an adjacent NE; and an interpreter for reading from the APS messages an identifier of a tunnel segment that occupies a predefined, a status of the identified tunnel segment, and a tunnel associated with the tunnel segment. The identifier of the tunnel provides a local identification of a tunnel passing through the tunnel segment.

The interpreter may further comprise a K-byte interpreter for interpreting K1 and K2 bytes of the frames to read the tunnel segment identifier, status, and the tunnel member; and an extension interpreter for reading a continuity of message indicator used to indicate at which frame the APS message begins and ends. The extension interpreter may further be adapted to read the continuity of message indicator that indicates that the APS message is one of the following: self-contained in the one K-byte overhead; contained in the current K-byte overhead in conjunction with that of at least the subsequent frame; a follow-on K-byte overhead; and a resent K-byte message.

The K-byte interpreter may be adapted to read a tunnel entity ID that identifies both the tunnel segment and the tunnel member. The tunnel member indicates whether the tunnel segment is a part of a working tunnel, or a protection tunnel, and if a protection tunnel, further indicates which of a predefined number of sharing protection tunnels is referenced. The tunnel entity ID may be an index of a packed lookup table.

The K-byte interpreter reads the status of the tunnel segment to identify a preemption priority value that identifies a reason for a protection switch request, the preemption priority value being associated with a hierarchy of the reasons for protection switch requests.

### BRIEF DESCRIPTION OF THE DRAWINGS

Further features and advantages of the present invention will become apparent from the following detailed description, taken in combination with the appended drawings, in which:

FIG. 1 schematically illustrates a shared mesh network that provides a 1:N protection scheme;

FIG. 2 schematically illustrates tunnel segments supported by an optical fiber link;

FIG. 3 is a schematic illustration of a converged SONET/SDH frame in accordance with the invention, including a K-byte overhead;

FIG. 4a is a schematic illustration of a K-byte signaling definition for a working or protection tunnel;

FIG. 4b is a schematic illustration of a follow-on K-byte signaling definition; and

FIG. 5. schematically illustrates a succession of automatic protection switching messages separated using the K-byte extension bits.

It will be noted that throughout the appended drawings, like features are identified by like reference numerals.

### DETAILED DESCRIPTION OF THE PREFERRED EMBODIMENT

The invention provides a method and apparatus for transmitting a message between adjacent network elements (NEs) of an optical network, in a format that permits message extension and the identification of a tunnel passing through a link between the adjacent NEs. The identification of the tunnel may be used to provide failure protection switching in a manner described in co-pending U.S. patent application ser. No. ______, entitled METHOD AND APPARATUS FOR PROTECTION SWITCH MESSAGING ON A FRAME-BASED SHARED MESH NETWORK, and incorporated herein by reference.

FIG. 1 schematically illustrates a portion of an optical network in which the invention is deployed. The portion of the optical network includes five NEs 10 (NE1, NE2, NE3, NE4, NE5), which may be geographically dispersed. The optical network is of a mesh topology. Specifically, the optical network is neither of a ring, nor a linear configuration, but is of a bidirectional mesh type, and in accordance with the present invention, use of K-bytes to permit fast protection switching on tunnels defined across the network, is provided.

The NEs 10 exchange data over bidirectional (i.e. full duplex) links 12 (specific bidirectional links between the identified NEs 10 are identified as 12a,b,c,d). Each bidirectional link 12 provides a data transport capacity that may or may not be wavelength division multiplexed, and includes two optical fiber links, each used for transporting data in opposite directions. A data transport capacity 16 of each bidirectional link 12 is divided to form a number of tunnel segments 14. As shown, the bidirectional links 12 may be of a same data transport capacity 16, and the data transport capacity 16 (schematically represented by a circular cross-section of the bidirectional link 12) is divided into logical tunnel segments 14, for example of ½, ¼, and ⅛ of the data transport capacity 16. For simplicity of illustration, only four of the tunnel segments 14 are shown.

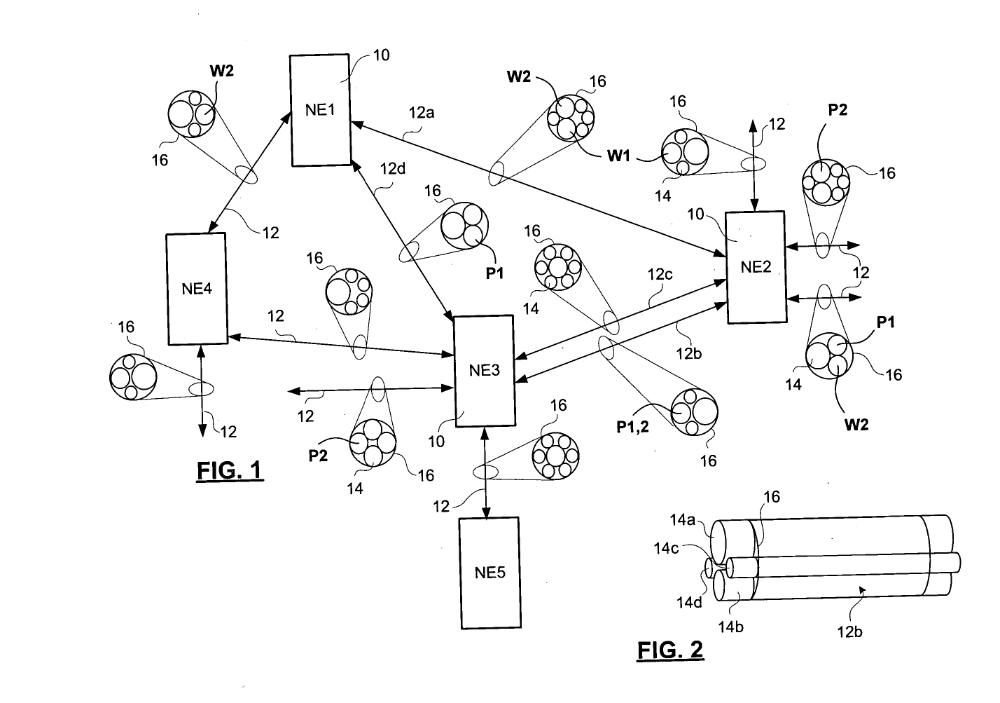

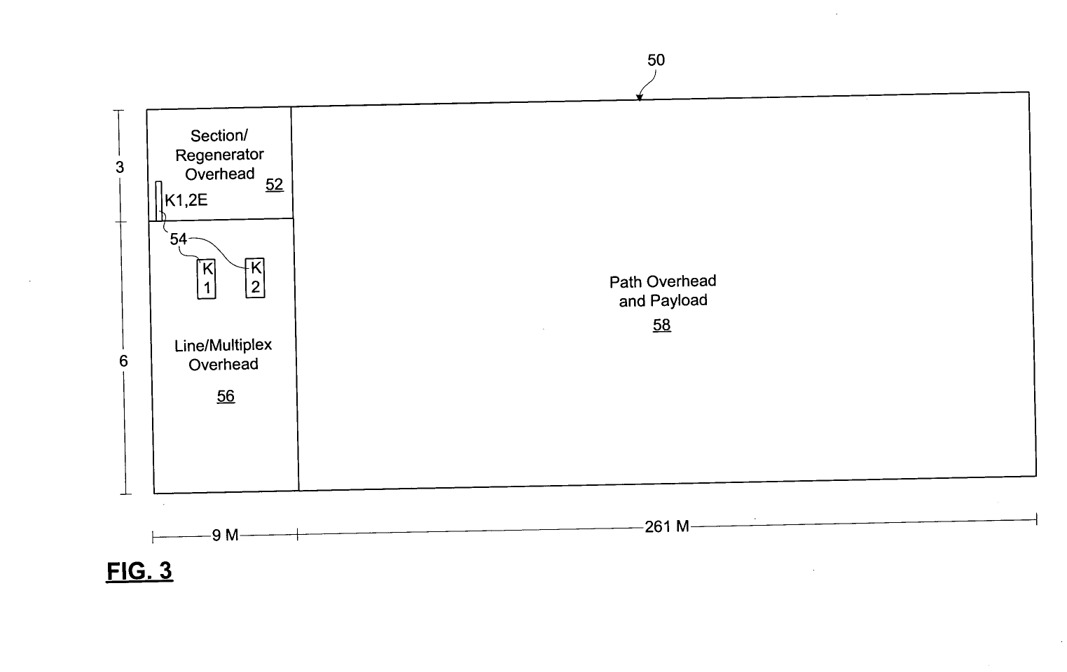

This division of data transport capacity on a bidirectional link 12b of FIG. 1, is schematically illustrated in FIG. 2, in which the data transport capacity 16 is divided to form a first tunnel segment 14a that constitutes half of the data transport capacity 16, a second tunnel segment 14b that constitutes a quarter of the data transport capacity 16, and two tunnel segments 14c,d that respectively constitute one eighth of the data transport capacity 16 (the reader is asked to discount the wedge shapes between the tunnels 14). It should be noted that tunnels are provisioned entities that are set up and taken down by a network management function. Accordingly a bidirectional link 12 is not expected to retain the same tunnel segment constitution over an extended period of time, and any set of logical tunnel segments 14 may be provisioned through the bidirectional link 12, as required.

With reference to FIG. 1 again; provisioned across the optical network are two identified working tunnels: W1, and W2 of the same capacity. The NE1 is an end point of the working tunnel W1; the other end point is not shown. The working tunnel W1 passes through NE2. More specifically working tunnel W1 occupies the tunnel segment 14 on bidirectional link 12a, between NE1 and NE2, that is switch-connected at NE2 to/from another working tunnel segment 14 of another bidirectional link 12. The working tunnel W2 begins and ends at NEs 10 that are not illustrated, but passes through NE1 and NE2, and occupies data transport on bidirectional link 12a.

Each of the working tunnels W1, W2 has a corresponding protection tunnel P1, P2. It is a general principle of protection switching that a protection path be as disjoint from the working path as possible. By minimizing a number of NEs and bidirectional links 12 that a working tunnel and its protection tunnel share, a probability that failure of a NE or an optical fiber link will result in both the working tunnel and the protection tunnel becoming non-operational is reduced. It is further desirable to minimize shared working resources between working tunnels that share a protection tunnel, so that failure of a resource does not result in competition for a protection tunnel. While all of W1, W2, and P1, P2 pass through NE2, neither W1 and P1, nor W2 and P2, share any bidirectional link 12.

The protection tunnel P1 has reserved data transport on the bidirectional link 12d, which extends from NE1 (one end of the tunnel), and through NE3 and terminates on an NE that is not shown in the diagram. P1 further reserves transport capacity of bidirectional link 12b between NE3 and NE2. The tunnel segment 14a reserved for protection tunnel P2, is also reserved for protection tunnel P1. This multiplicity of reservation is permitted in a 1:N protection scheme, wherein each working tunnel can “share” any part of its protection path, with up to N other working tunnels. It should be noted that while a working tunnel “occupies” its tunnel segments 14, a protection tunnel merely “reserves” the tunnel segments 14.

A characteristic of revertive protection schemes, that once a working tunnel is switched to a protection tunnel, and the reason for switching (usually a condition of the working tunnel that led to a request for switching, or a network management requested switch) is removed, the protection tunnel is de-selected and the occupation of the protection tunnel is ceded. More specifically, if a network management request for switching to a protection path is received, it is followed by a release, at which point the protection path is released. If a protection switch is required by a working path failure, generally a predefined wait to restore time elapses before reversion to the working path. While the present invention is independent of such protection scheme electives, it shall be described herein with reference to a revertive protection scheme.

FIG. 3 schematically illustrates a frame 50 that conforms with a converged optical network data transmission format. Specifically, the Synchronous Optical NETwork (SONET) standard and the Synchronous Digital Hierarchy (SDH) optical network standard provide similar transmission level protocols for optical networking, and these protocols permit interoperability. The result is a specification of the frame 50 that is of 9×270M byte dimension. The whole number M indicates a multiplex number of the frame, and corresponds to a number of SDH synchronous transport mode (STM-1) frames or SONET synchronous transport signal (STS-3c) frames which are byte-interleaved to form the frame 50. The STSs and STMs are well known in the art, as is the converged frame 50 formed therewith. In broad overview, the frame 50 includes a section (the SONET term) or a regenerator (the SDH term) overhead 52 that is used by all signal relay equipment that receives and regenerated the data, but does not switch the tunnel data, and does not inspect any part of the frame, other than the section/regenerator overhead 52. Two bits of unused section/regenerator overhead 52 have been appropriated to provide a K-byte extension, and form a part of a K-byte overhead 54, in accordance with an embodiment of the invention. Alternatively, other overhead bits that are not assigned can be used for this purpose, in equivalent fashion.

The larger part of the K-byte overhead 54 is found in a line (the SONET term) or multiplex (the SDH term) overhead 56. More specifically, the K1 byte (the 5^{th} row, 3M+1^{th} column, byte) and the K2 byte (the 5^{th} row, 6M+1^{th} column, byte) are used in the prior art to provide protection switching. Accordingly these K1, K2 bytes are devoted to APS messaging. In accordance with the illustrated embodiment, the K1, K2 bytes and K1E, K2E bits are collectively used to provide an extended automatic protection switching (APS) channel that is used to signal failures of links, and to coordinate switching of NEs, to permit and control protection switching, in either a manner known in the art, or in the manner taught in the above-identified co-pending United States patent application.

Hardware and software of the NE (of FIG. 1) for processing SONET/SDH standard APS messages are currently available, and in wide use. The K1, K2 bytes are read with high priority interrupt-based handling that ensures that when the K1, K2 bytes are changed, an APS signal processor is immediately notified. The hardware is therefore fast and able to provide the K1, K2 byte messaging. In accordance with the invention, the APS signal processor is provided with an interpreter for receiving the K1 and K2 bytes, and reading the tunnel entity ID, and the status of the tunnel, so that it can select a handling of the APS message. The interpreter may be divided into a K-byte interpreter for reading the K1, K2 bytes, and an extension interpreter for reading the K1E, K2E bits.

The frame 50 may specifically be any one of an STS-3/STM-1, STS-12/STM-4, STS-48/STM-16, STS-192/STM-64, STS-768/STM-256, etc. converged SONET/SDH frames. Alternatively the frames may be any standard SONET or standard SDH frames, or proprietary versions thereof. It may further be obvious to the person skilled in the art how to apply the same principles to other network protocols. A path overhead and payload 58 provides the content of the frame 50, transporting data in a manner well known in the art.

Each frame 50 is conveyed over a respective optical fiber link, such as one of the two optical fiber links forming the bidirectional link 12 (FIG. 1), at a predefined rate (8000 frames/second). The division of the data transport capacity corresponds to a division of the path overhead and payload 58. In principle, the frame can be cleaved into M tunnels, however, in practice too fine a tunnel granularity may pose problems in terms of identifying and controlling the tunnels, and generally provides diminishing advantage compared with the complexity of implementation.

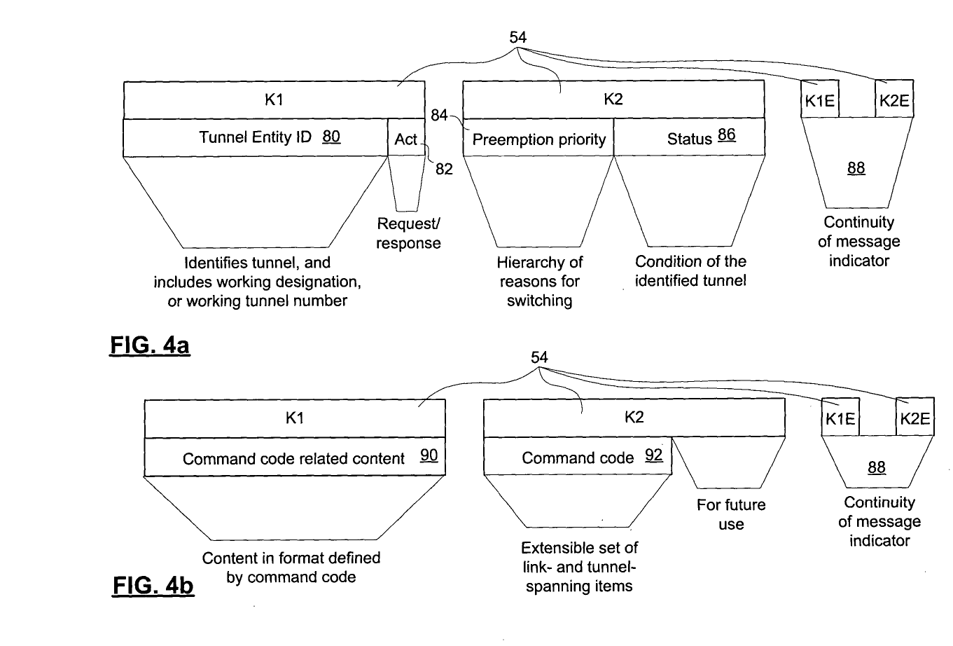

An exemplary signaling definition of K-bytes that permits the identification of a tunnel segment and a tunnel member, is shown in FIGS. 4a,b. In FIG. 4a, a message definition is provided for the K1, K2 bytes and K1E, K2E bits, to define a working/protection message. FIG. 4b illustrates a message format used for extensions to working/protection messages.

As shown in FIG. 4a the K1 byte includes a 7-bit tunnel entity field 80, and an action bit 82. The tunnel entity field 80 contains a tunnel entity identifier (ID) that uniquely identifies a tunnel segment 14, and if the tunnel segment 14 is used for protection, identifies a tunnel member associated with a particular one of the N protection tunnels. The tunnel member is one (of upto N) protection tunnel(s) that reserves bandwidth of the tunnel segment 14. An example of a mapping from the tunnel segment and tunnel member to the 7-bit value is presented in Table 1 below. Table 1 assumes that up to 15 tunnel segments can be referenced on the link, and that up to 3 working tunnels can reserve a given protection tunnel segment through the link.

TABLE 1

| Tunnel Entity ID | Tunnel member | Tunnel segment |
|---|---|---|
| 1 | Working | All |
| 2 | Protection 1 | |
| 3 | Protection 2 | |
| 4 | Protection 3 | |
| 5 | Working | First half |
| 6 | Protection 1 | Tunnel 1 |
| 7 | Protection 2 | |
| 8 | Protection 3 | |
| 9 | Working | Second half |
| 10 | Protection 1 | Tunnel 2 |
| 11 | Protection 2 | |
| 12 | Protection 3 | |
| 13 | Working | First quarter |
| 14 | Protection 1 | Tunnel 1 |
| 15 | N/A | Local message ID |
| 16 | Protection 2 | First quarter |
| 17 | Protection 3 | Tunnel 1 |
| 18 | Working | Second quarter |
| 19 | Protection 1 | Tunnel 2 |
| 20 | Protection 2 | |
| 21 | Protection 3 | |
| 22 | Working | Third quarter |
| 23 | Protection 1 | Tunnel 3 |
| 24 | Protection 2 | |
| 25 | Protection 3 | |
| 26 | Working | Fourth quarter |
| 27 | Protection 1 | Tunnel 4 |
| 28 | Protection 2 | |
| 29 | Protection 3 | |
| 30 | Working | First eighth |
| 31 | Protection 1 | Tunnel 1 |
| 32 | Protection 2 | |
| 33 | Protection 3 | |
| 34 | Working | Second eighth |
| 35 | Protection 1 | Tunnel 2 |
| 36 | Protection 2 | |
| 37 | Protection 3 | |
| 38 | Working | Third eighth |
| 39 | Protection 1 | Tunnel 3 |
| 40 | Protection 2 | |
| 41 | Protection 3 | |
| 42 | Working | Fourth eighth |
| 43 | Protection 1 | Tunnel 4 |
| 44 | Protection 2 | |
| 45 | Protection 3 | |
| 46 | Working | Fifth eighth |
| 47 | Protection 1 | Tunnel 5 |
| 48 | Protection 2 | |
| 49 | Protection 3 | |
| 50 | Working | Sixth eighth |
| 51 | Protection 1 | Tunnel 6 |
| 52 | Protection 2 | |
| 53 | Protection 3 | |
| 54 | Working | Seventh eighth |
| 55 | Protection 1 | Tunnel 7 |
| 56 | Protection 2 | |
| 57 | Protection 3 | |
| 58 | Working | Eighth eighths |
| 59 | Protection 1 | Tunnel 8 |
| 60 | Protection 2 | |
| 61 | Protection 3 | |

It will be noted that the exemplary mapping is a particular mapping that can only be applied for certain NEs of given configurations. The tunnel entity field 80 is 7 bits (128 values) in the illustrated example, there are 15 referenced tunnels, and sharing of upto 15 tunnel members could therefore be included, although sharing of N=3 is chosen for brevity. Bellcore's standards specify that at most 14 working tunnels can share a single resource.

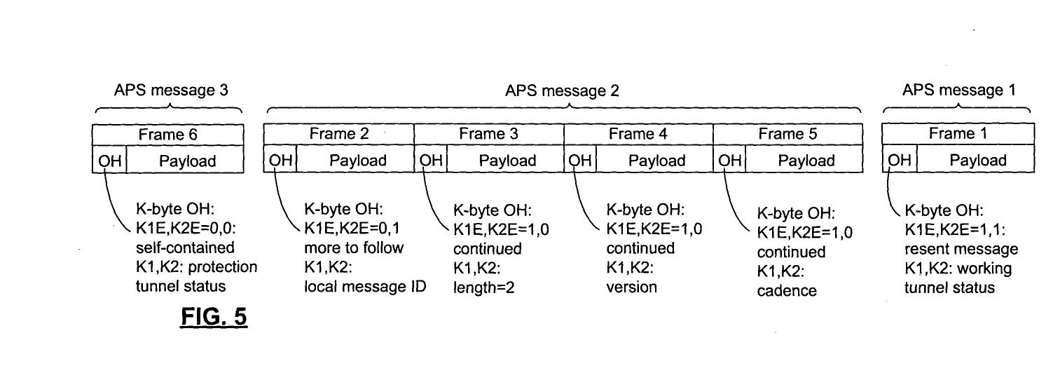

Preferably a bit pattern is used as a local message identifier, and identifies a class of messages that are used to coordinate action between adjacent NEs. Such messaging can be used when an NE becomes available after a restart, for messages relating to extra traffic, etc. More completely, the K1, K2-byte pattern (HEX): 1E EC is used to identify a local message. This pattern was chosen because one of the uses for these local messages involves startup messaging that is used to identify tunnels, set a cadence, etc. (an example of which is described below with reference to FIG. 5). As these start-up messages may be performed after manual optical fiber interconnection, and the interconnection of many optical fiber links in complex switching sites is an involved and error-prone activity, it is useful to provide initial messages that verify that the optical fibers are correctly interconnected at the NE. Furthermore, at start-up an NE may be interconnecting to NEs that are already carrying traffic. The selection of 1E. EC is used because linear and ring standard networks consider 1E EC to be a generally unexpected combination of K1, K2 bytes, and accordingly report an error, if a transmit port of the shared mesh NE is interconnected to a receive port of a linear or a bi-directional line switched ring (BLSR) connected NE. There are therefore two important advantages of this use of the 1E EC bit pattern: that the APS messages are never forwarded by NEs to a next hop in the network, and that they may facilitate error indications when the optical fibers are incorrectly interconnected.

Other than the fact that the tunnel entity ID bit pattern “15” is always used for this purpose, and possibly that 1 always refers to the whole data transport capacity that is a part of a working tunnel, there is no necessary correspondence between the tunnel entity IDs associated with a link between a first NE and a second NE1, and the tunnel entity ID for the same tunnel between the second NE and a third NE. In fact the links may be supported by different numbers of optical fibers, may use different receiver and transmitter equipment, and/or may employ wavelength division multiplexing, and accordingly have different respective data transport capacities. Other links may have different shared protection limitations. The tunnel entity ID for a protection tunnel is intended as a purely local identifier of a working tunnel, so that messages from different ends of respective working tunnels can be differentiated at the NE. As each link may use a different table of tunnel entities 80, the tunnel entities 80 may be said to be an index to a packed lookup table.

Because a protection tunnel segment is associated with its set of tunnel members for locally identifying respective protection tunnels, most messages over a protection tunnel are identified by the tunnel entity ID associated (by the local tunnel member) with a protection tunnel. However, in some cases a tunnel segment might be reserved by N protection tunnels, but an APS message that does not relate to any one of the protection tunnels in particular, or to all of the protection tunnels together, could use the working tunnel entity ID of the tunnel segment to issue a message associated with all of the protection tunnels, or associated with the tunnel segment with no reference to any particular tunnel member. As no protection tunnel member is identified in such messages, the message will necessarily be a one-hop or local message. One example of where this type of message may be useful involves notifying adjacent NEs of the status of extra traffic transported over the protection tunnel segment.

The action bit 82 follows the tunnel entity field 80. This bit is used to indicate whether the message is a response to a previously received message, or a message prompted by a changed state of one of the NEs in the tunnel.

The K2 byte includes a preemption priority field 84, and a status field 86. The preemption priority field 84 principally indicates a value in a hierarchy of conditions that prompts a request for a switch to a protection tunnel. For example, any request for a switch from a working tunnel to a protection tunnel includes an indication of the cause (e.g. the working tunnel has failed, or is degraded, a manual switch or a forced switch has been requested by network management, an exerciser has been effected, etc.). The NEs associate these causes with values in a preemption hierarchy, that may be the priority hierarchy illustrated in Table 2.

TABLE 2

| Nibble | Priority | | Reason for requesting |
|---|---|---|---|
| value | level | Name | protection switch |
| 0 | 1^{st} | No priority | Switch not requested or |
| | | | reversion requested |
| 1 | 2^{nd} | Exerciser | Exerciser software |
| | | | requests access for |
| | | | testing |
| 2 | 3^{rd} | Extra traffic | Extra traffic of low |
| | | low | priority is using |
| | | | protection tunnel segment |
| 3 | 4^{th} | Not currently used | |
| 4 | 5^{th} | Waiting to | A working tunnel has |
| | | restore | access to the protection |
| | | | tunnel, while a tunnel |
| | | | condition that led to the |
| | | | switch has been cleared |
| 5 | 6^{th} | Manual switch | The network management |
| | | | has requested a low |
| | | | priority switch with no |
| | | | traffic hit |
| 6 | 7^{th} | Signal degrade | A low service working |
| | | low | tunnel has detected a |
| | | | signal degrade condition |
| 7 | 8^{th} | Signal degrade | A medium service working |
| | | medium | tunnel has detected a |
| | | | signal degrade condition |
| 8 | 9^{th} | Signal degrade | A high service working |
| | | high | tunnel has detected a |
| | | | signal degrade condition |
| 9 | 10^{th} | Extra traffic | Extra traffic of medium |
| | | medium | priority is using |
| | | | protection tunnel segment |
| 10 | 11^{th} | Signal fail | A low service working |
| | | low | tunnel has detected a |
| | | | signal fail condition |
| 11 | 12^{th} | Signal fail | A medium service working |
| | | medium | tunnel has detected a |
| | | | signal fail condition |
| 12 | 13^{th} | Signal fail | A high service working |
| | | high | tunnel has detected a |
| | | | signal fail condition, or |
| | | | a tunnel condition exists |
| | | | on protection tunnel |
| 13 | 14^{th} | Extra traffic | Extra traffic of medium |
| | | high | priority is using |
| | | | protection tunnel segment |
| 14 | 15^{th} | Forced switch | The network management |
| | | | demands a switch |

| | | |
|---|---|---|
| 15 | 16^{th} | Not currently used |

It should be noted that not all of these priority hierarchy values can be associated with requests for switching to a protection tunnel. Specifically extra traffic priority levels 3, 10, 14 are used by NEs to select handling of protection switch requests, but these priority levels may not be transmitted in any APS messages. Rather extra traffic is provisioned in a manner well known in the art, that does not use the APS channel. Further the extra traffic is handled on a hop-by-hop basis, and need not follow a continuous protection tunnel, and so does not use end-to-end signaling (which is the default for K-byte messages). A further description of extra traffic is found in co-assigned co-applicants, U.S. patent application Ser. No. ______ entitled METHOD AND APPARATUS FOR PROVIDING GRADES OF SERVICE FOR UNPROTECTED TRAFFIC, which is incorporated herein by reference.

The exerciser, manual switch, and forced switch priorities are issued by network management operations, which may be partially automated. APS messages including these preemption priorities are generally initiated from one or both ends of the tunnels. It should be manifest that the ends of a working tunnel are also the ends of the protection tunnels. The exerciser is a software program used to verify readiness of a protection tunnel. This is generally a very low priority activity, and is often scheduled during periods of relatively low network traffic load.

The signal fail and signal degrade conditions may be initiated by any NE detecting a failure of a tunnel segment with an adjacent NE. In preferred embodiments, a signal degrade on a protection tunnel is not transmitted. It is well known in the art that frame reception equipment that is currently in use is designed to overwrite the last three bits of the K2 byte with 111 to indicate a failure of the link. This may be detected by regenerator equipment in between NEs, resulting in an alarm indication signal (AIS). Remote defect indications (RDIs) (signaled by 110) may also be transmitted and detected from a reverse direction. Such error conditions are used to indicate failures of the links, in a manner well known in the art. A tunnel condition is used to indicate that another segment of the tunnel has failed, so that notice of such failures are conveyed to the ends of the tunnels affected by the failure. When an end of a working or protection tunnel receives notice of a tunnel condition, it determines if the tunnel is currently carrying live traffic. If the tunnel is carrying live traffic, that traffic has been impacted by the tunnel condition, and has to be switched to the protection tunnel (if the failed tunnel is a working tunnel), or back to the working tunnel (if the tunnel is a protection tunnel). Switching back to a working tunnel is equivalent to relinquishing occupation of the failed protection tunnel, and switching the traffic back to the working tunnel (regardless of whether the working tunnel condition is cleared). Switching to the protection tunnel requires APS messaging over the protection tunnel requesting the protection switch. In a hop-by-hop process, access to each protection tunnel segment is independently requested and the priority of the request (signal fail or signal degrade, with the associated grade of service of the working tunnel) is included in the messages.

The waiting to restore priority value is used when a tunnel has been switched to the protection tunnel, and the working tunnel condition is cleared. As noted above, the protection switching scheme is revertive, so that in order to verify the operation of a working tunnel that has a cleared tunnel condition, a waiting to restore timer is set at the ends of the working tunnel, and elapses prior to switching back to the working tunnel.

There is a sense in which the preemption priority 84 field is overloaded. The condition usually relates to a condition of the working tunnel (regardless of whether the tunnel segment passing the message is working or a protection tunnel), but if the tunnel segment is used for protection, and the status indicates that there is a tunnel condition, the preemption priority value (that is chosen from a subset of the priority values) refers to that of the protection tunnel, and not the working tunnel. Accordingly each of the protection tunnels passing through a respective protection tunnel segment is sent a respective K-byte message indicating the failure of its protection tunnel.

The status field 86 indicates such facts as: a condition of the identified tunnel; a state of occupancy of the identified tunnel; and a status of a protection switch request. More specifically, the condition of the tunnel is specified by a tunnel condition identifier, which indicates that the tunnel of the link supporting the APS message (as opposed to the tunnel member's associated protection tunnel) is in a signal fail, or signal degrade condition. The tunnel condition identifier may further be used in tunnel provisioning verification procedures. As previously noted, a signal degrade condition of a protection tunnel may not be exchanged, and the manner in which a tunnel condition is detected is known in the art. The preemption priority of an APS message is ignored when an AIS or RDI is received, and the tunnel condition messages are sent.

The state of occupancy of a working tunnel indicates whether traffic is switched onto the working tunnel or its protection tunnel. Switching means selecting one of two bidirectional switch-connected tunnels that is to be used for transporting traffic (payload data). The traffic is actually transmitted over both tunnels concurrently when the protection tunnel is selected, in most embodiments of a revertive protection scheme, but is only transmitted over the working tunnel, otherwise. Selecting the tunnel therefore amounts to choosing the tunnel on which the traffic is read.

On protection tunnels, the state of occupancy is more complicated. The traffic can be selected, or not when the protection tunnel segments are switch-connected between the tunnel ends; i.e. in a bridged condition. Accordingly bridged (and not switched), and idle (not bridged) are two more conditions of the tunnels identified in the status field 64, in APS messages sent along protection tunnels. An idle status indicates that the protection tunnel is not carrying corresponding traffic.

Finally a status of a request for a protection switch is further supplied in the status field 86. The status of a request includes that it may be pended or backed-off, or that it is accepted (which is indicated by an idle status). A pended request is one that is not allowed by at least one of the tunnel segments of the protection tunnel. The request may be refused because a higher (or equal) priority protection tunnel segment occupies the tunnel segment; extra traffic of a higher priority occupies the protection tunnel segment; or the protection tunnel is locked out. A backed-off status is indicated when a working tunnel that is bridged on the protection tunnel is ordered to cede a protection tunnel segment, e.g. because a higher priority protection tunnel segment has requested the tunnel segment; or the protection tunnel segment is locked out.

The K-byte extension bits K1E, K2E form a continuity of message field 88 used to indicate message continuity. In one embodiment, the message continuity field 88 provides an indication 1) that the message is a follow-on K-byte overhead, and should be associated with the previous K-byte overhead; 2) that the message is self-contained; 3) that the message is to be interpreted as a self-contained K-byte, but that at least one follow-on K-byte overhead will follow, or 4) that the K-byte message is a resent on request message. An example of how the K1E, K2E bits are used is described below with reference to FIG. 5. As the K1, K2 bytes of FIG. 4a are in the format of self-contained messages, the continuity of message indicators will not indicate 1), which is the only indicator used in follow-on K-bytes of the form shown in FIG. 4b.

FIG. 4b schematically illustrates an embodiment of a definition for a follow-on K-byte overhead. The message continuity field 88 was described above, and the K1-byte 90 contains content related to a command code, the command code being identified by the first 5 bits of the K2-byte, called the command code field 92. It will be appreciated by those skilled in the art that if a link fails during a frame containing follow-on K-byte overhead, the last three bits are overwritten. This failure needs to be detectable, and accordingly only 6 bit patterns of the 3 bits that remain in the K2 byte are available for future use.

The command codes indicate a type of the follow-on K-bytes, and further dictate an interpretation of the K1 byte 90. A few examples of command codes that are currently defined are: a version follow-on K-byte used to indicate a version of the protocol for interpreting the follow-on K-byte message; a cadence follow-on K-byte used to indicate a limit on a number of successively validated frames that must pass before a new K-byte overhead is transmitted; a valid tunnel entity ID follow-on K-byte overhead; and an invalid tunnel entity ID follow-on K-byte overhead. The version follow-on K-byte makes the follow-on K-byte overhead an extensible protocol that can be updated to include a variety of message types. The cadence follow-on K-byte is used to assert the rate at which new K-byte overheads can be forwarded to a receiving NE. The cadence is naturally an integer multiple of 0.125 ms: the frame rate in SONET, SDH, and converged SONET/SDH standards. The cadence, valid tunnel entity ID, and invalid tunnel entity ID follow-on K-byte overheads are only used for local signaling as the tunnel entity IDs and cadence have only a local significance. Each NE has to maintain the K-byte overheads in a buffer that gets overwritten when full. It is therefore important to ensure that K-byte overheads are not received from any of the NEs that connect tunnels through the NE, at a rate that exceeds a capacity of the hardware that handles the K-byte messaging. If more than one follow-on K-byte overhead is to be sent, a second K-byte overhead (i.e. a first follow-on K-byte overhead) is a length follow-on K-byte overhead, the K1-byte 90 of which indicates the number of sequentially validated frames used to transport the message.

Numerous other follow-on K-byte message types, and their uses, are currently defined for local exchange. The number of tunnels referenced on the link is sent in a tunnel number follow-on K-byte message, and the sharing number (i.e. the number N of working tunnels that can reserve a protection tunnel segment over the link) is sent in a sharing number follow-on K-byte message. A request for retransmission of previous K-byte overheads is made in a resend follow-on K-byte message. If the numerous tunnels passing through a given tunnel segment all happen to be transmitting new K-byte overheads, the NE's transmitter/receiver on the tunnel segment may become overloaded, and consequently send, in a reverse direction, a stop sending follow-on K-byte message to one or more of the previous NEs in the respective tunnels. The stop sending follow-on K-byte message may indicate a time after which to resume, or a separate recommence sending follow-on K-byte message may be used. It will be evident to those skilled in the art that other messages for controlling transmission of K-byte messages, and relating to tunnels on the link, can be defined.

Some further end-to-end follow-on K-byte messages are also defined. For example a correlation number may be transmitted to provide a non-local identifier of the working tunnel associated with a respective one of the tunnel members passing through each of the tunnel segments. Such identifiers may require two or more bytes of data to transmit, and accordingly the correlation number may be sent in two or more successive follow-on K-byte messages. A message indicating that a NE in the tunnel has received an unacceptable bit pattern with a valid tunnel entity ID may be passed to the ends of the tunnel, which may be useful for identifying protocol version mismatches. Furthermore, if a tunnel is only partly provisioned, and an APS message is sent along the protection tunnel, some NE will receive the reference to a tunnel entity that is not recognized. A unrecognized tunnel entity follow-on K-byte is defined, so that upon receipt of a K-byte message addressed to an unknown tunnel entity, the NE will return the APS message with the unknown tunnel entity to the sending NE, followed by the unrecognized tunnel entity follow-on K-byte. As well, a hop count that identifies a number of NEs between the ends of a tunnel can be included in a tunnel monitoring follow-on K-byte message. Other end-to-end capabilities can be enabled with corresponding end-to-end follow-on message types.

FIG. 5 schematically illustrates an example of a sequence of APS messages that may be sent over a link in a network, in accordance with the illustrated embodiment of the invention. A first K-byte overhead, in the overhead portion of frame 1 is a self-contained APS message 1 indicating a status of a working tunnel identified in the tunnel entity field 80. The K1E, K2E bits are set to 1,1, indicating that the APS message 1 is a resent message requested in a local resend follow-on K-byte overhead APS message transmitted over a paired link in the reverse direction.

The APS message 2 is transported in overheads of 4 successively validated frames. The first frame contains the K1, K2 bit pattern of the local message ID, and so the APS message 2 is a local message. No particular tunnel entity is specified as the message pertains to the whole link, and may be sent even prior to the identification of any tunnels on the link. The K1E, K2E bits are set to 1,0, indicating that the K1, K2-bytes are to be interpreted according to the self-contained K-byte overhead signaling definition, but that the APS message 2 continues on at least a K-byte overhead of a next frame (frame 3). Frames 3-5 have the K1E, K2E bits set to 1,0 to indicate that the K1, K2-bytes are to be interpreted as follow-on K-bytes. More specifically, frame 3 conveys a length follow-on K-byte, frame 4 conveys a version follow on K-byte, and frame 5 conveys a cadence follow-on K-byte, as described above.

The K1E, K2E bits of frame 6 are null, indicating that APS message 3 is self-contained. It should be noted that in order to minimize occupation of buffers, the number of K-byte overheads used to transport a message is preferably minimized. This is particularly important for end-to-end messaging, in which at each NE in the tunnel the message has to be received in its entirety before being relayed to a next NE. This results in some end-to-end transmission time. The occupation of the buffer space is problematic because switch request messages need to be acted on immediately, and delays caused by queues may be unacceptable. It is therefore advisable to define follow-on K-byte messages for information that is rarely transmitted over the APS channel. The frequently transmitted K-byte overhead format includes the tunnel entity ID, and the status of the relevant tunnel permitting one K-byte overhead messaging for protection switching.

The invention has been described in the context of a particular embodiment of a shared mesh network, however, any network transmitting SONET/SDH-type frames that are divided to form tunnels can apply the invention to enable robust, efficient protection switching.

The embodiment(s) of the invention described above is(are) intended to be exemplary only. The scope of the invention is therefore intended to be limited solely by the scope of the appended claims.

1. A method for transmitting an automatic protection switching (APS) message from a first network element (NE) to a second NE of a frame-based optical network, the method comprising:
inserting into a K-byte overhead of a frame sent over a link from the first NE to the second NE, information used to determine a predefined proportion of the link's capacity to which the APS message is related, a tunnel with which the proportion of the link's capacity is associated, and status information related to that tunnel.

2. The method as claimed in claim 1 further comprising:
examining information to be sent in the APS message; and
using a continuity of message indicator in an overhead of the frame to indicate that a balance of the APS message is being sent in K-byte overhead of at least one subsequent frame.

3. The method as claimed in claim 1 wherein inserting the information comprises inserting a tunnel entity ID that identifies both the proportion of the link's capacity, and the tunnel, which provides a local identifier of one of a working tunnel occupying the proportion of the link's capacity, and a protection tunnel reserving the proportion of the link's capacity.

4. The method as claimed in claim 3 wherein inserting the tunnel entity ID comprises inserting an index of a packed lookup table.

5. The method as claimed in claim 3 wherein inserting the status information of the tunnel segment further comprises inserting a preemption priority value that identifies a reason for a protection switch request, the preemption priority value being associated with a hierarchy of the reasons for the protection switch requests.

6. The method as claimed in claim 5 wherein inserting the preemption priority value further comprises inserting an identifier of the preemption priority value associated with both a condition of, and a grade of service of, a tunnel associated with the tunnel member.

7. The method as claimed in claim 6 wherein inserting the status information further comprises indicating:
a state of occupancy of the tunnel segment by the working tunnel associated with the tunnel member, if the tunnel segment is a protection tunnel segment;
whether the tunnel segment is selected, and is therefore transporting traffic of the working tunnel associated with the tunnel member, or the working tunnel member passing through the tunnel segment; and
a signal failure or a signal degrade condition of the tunnel occupying the tunnel segment.

8. A method for transmitting a message on an automatic protection switch channel between a first network element (NE) and a second NE of an optical network, the method comprising:
sending a first K-byte overhead followed by one or more follow-on K-byte overheads in respective sequentially validated frames over a link between the first and second NE, and using at least a continuity of message indicator of the first and follow-on K-byte overheads to indicate a beginning, and an end of the message.

9. The method as claimed in claim 8 wherein using the at least the continuity of message indicator comprises:
setting a continuity of message indicator in the first K-byte overhead to indicate that it is a first of an extended message; and
if the message requires more than one follow-on K-byte overhead, creating a first follow-on K-byte overhead of a corresponding frame, the first follow-on K-byte overhead including a length field for indicating a number of K-byte overheads in the message.

10. The method as claimed in claim 8 further comprising setting the continuity of message indicator in the follow-on K-byte overheads so that each K-byte overhead that is part of the extended message is identifiable as such.

11. The method as claimed in claim 8 further comprising inserting into the first K-byte overhead information that can be used to determine a predefined proportion of the link's capacity; a tunnel associated with the proportion of the link's capacity; and status information related to that tunnel.

12. The method as claimed in claim 11 further comprising:
determining if the message is for adjacent NE signaling; and
inserting a local message identifier into the K-byte overhead, if the message is limited to adjacent NE signaling.

13. The method as claimed in claim 12 wherein inserting a local message identifier comprises inserting a bit pattern that is not generally used in K-byte overheads of standard frame-based optical networks, to assist in troubleshooting network equipment connection.

14. The method as claimed in claim 8 wherein sending the one or more follow-on K-byte overheads further comprises inserting a command code in the K-byte overhead that identifies how a content field of the K-byte overhead is to be interpreted, and inserting the content into the content field, the content being used for at least one of: controlling transmission of K-byte messages, and managing tunnels provisioned across the link

15. An automatic protection switch (APS) signal processor of a network element (NE) of a mesh-connected, frame-based optical network, the APS signal processor comprising:
a receiver for receiving APS messages in a K-byte overhead of frames transported over a link from an adjacent NE;
an interpreter for reading from the APS messages, information used to determine a predefined proportion of the link's capacity; a tunnel associated with the proportion of the link's capacity; and status information related to that tunnel.

16. The APS signal processor as claimed in claim 15 wherein the interpreter further comprises:
a K-byte interpreter for interpreting K1 and K2 bytes of the frames to read the tunnel segment identifier, status, and the tunnel member; and
an extension interpreter for reading a continuity of message indicator used to indicate at which frame the APS message begins and ends.

17. The APS signal processor as claimed in claim 16 wherein the extension interpreter is further adapted to read the continuity of message indicator that indicates that the APS message is one of the following: self-contained in the one K-byte overhead; contained in the current K-byte overhead in conjunction with that of at least the subsequent frame; a follow-on K-byte overhead; and a resent K-byte message.

18. The APS signal processor as claimed in claim 16 wherein the K-byte interpreter is adapted to read a tunnel entity ID that identifies both the tunnel segment and the use, which identifies a tunnel member providing a local identifier of one of a working tunnel occupying the proportion of the link's capacity, and a protection tunnel reserving the proportion of the link's capacity.

19. The APS signal processor as claimed in claim 18 wherein the reading the tunnel entity ID comprises reading an index of a packed lookup table.

20. The APS signal processor as claimed in claim 18 wherein the K-byte interpreter reads the status of the tunnel segment to identify a preemption priority value that identifies a reason for a protection switch request, the preemption priority value being associated with a hierarchy of the reasons for protection switch requests.
